(19) United States
(12) Patent Application Publication
(10) Pub. No.: US 2022/0067785 A1
(43) Pub. Date: Mar. 3, 2022

(54) CONTEXT-BASED CONTENT INJECTION INTO CONTENT STREAM

(71) Applicant: LENOVO (Singapore) PTE. LTD., New Tech Park (SG)

(72) Inventors: Nathan J. Peterson, Oxford, NC (US); Arnold S. Weksler, Raleigh, NC (US); Russell Speight VanBlon, Raleigh, NC (US); Mark Patrick Delaney, Raleigh, NC (US); John C. Mese, Cary, NC (US)

(21) Appl. No.: 17/004,849

(22) Filed: Aug. 27, 2020

(51) Int. Cl. G06Q 30/02; G01C 21/34

(52) U.S. Cl. CPC G06Q 30/0261; G06Q 30/0269; G01C 21/3484; G06Q 30/0252; G01C 21/3407; G06Q 30/0255

(57) ABSTRACT

Apparatuses, methods, systems, and program products are disclosed for context-based content injection into content stream. An apparatus includes a processor and a memory that stores code executable by the processor. The code is executable by the processor to determine a current context of a user, the current context of the user comprising one or more current environmental circumstances associated with the user, determine content to present to the user that is relevant to the user's current context, and dynamically inject the determined content into a current content stream that the user is consuming.

### FIELD

The subject matter disclosed herein relates to targeted content and more particularly relates to context-based content injection into content stream.

### BACKGROUND

Advertisements are prevalent in media, games, and/or other applications. Typically, these advertisements are general in nature and are not targeted directly to the user based on the user's context.

### BRIEF SUMMARY

Apparatuses, methods, systems, and program products are disclosed for context-based content injection into content stream. An apparatus, in one embodiment, includes a processor and a memory that stores code executable by the processor. In certain embodiments, the code is executable by the processor to determine a current context of a user, the current context of the user comprising one or more current environmental circumstances associated with the user, determine content to present to the user that is relevant to the user's current context, and dynamically inject the determined content into a current content stream that the user is consuming.

A method for context-based content injection into content stream, in one embodiment, includes determining, by a processor a current context of a user, the current context of the user comprising one or more current environmental circumstances associated with the user, determining content to present to the user that is relevant to the user's current context, and dynamically injecting the determined content into a current content stream that the user is consuming.

A computer program product for context-based content injection into content stream, in one embodiment, includes a computer readable storage medium having program instructions embodied therewith. In certain embodiments, the program instructions are executable by a processor to cause the processor to determine a current context of a user, the current context of the user comprising one or more current environmental circumstances associated with the user, determine content to present to the user that is relevant to the user's current context, and dynamically inject the determined content into a current content stream that the user is consuming.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for context-based content injection into content stream;

FIG. 2 is a schematic block diagram illustrating one embodiment of an apparatus for context-based content injection into content stream;

FIG. 3 is a schematic block diagram illustrating one embodiment of another apparatus for context-based content injection into content stream;

FIG. 4 is a schematic flow chart diagram illustrating one embodiment of a method for context-based content injection into content stream; and

FIG. 5 is a schematic flow chart diagram illustrating one embodiment of another method for context-based content injection into content stream.

### DETAILED DESCRIPTION

As will be appreciated by one skilled in the art, aspects of the embodiments may be embodied as a system, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Apparatuses, methods, systems, and program products are disclosed for context-based content injection into content stream. An apparatus, in one embodiment, includes a processor and a memory that stores code executable by the processor. In certain embodiments, the code is executable by the processor to determine a current context of a user, the current context of the user comprising one or more current environmental circumstances associated with the user, determine content to present to the user that is relevant to the user's current context, and dynamically inject the determined content into a current content stream that the user is consuming.

In one embodiment, the current context of the user comprises a current location for the user, the determined content associated with the user's location. In further embodiments, the determined content comprises an advertisement for a product and/or service within a proximity of the user's current location.

In some embodiments, the code is executable by the processor to dynamically determine directions from the user's current location to a location associated with the advertisement and inject the dynamically determined directions into the advertisement. In various embodiments, the code is executable by the processor to dynamically determine an amount of time for the user to arrive at the location associated with the advertisement from the user's current location and inject the determined amount of time into the content stream as part of the advertisement.

In one embodiment, the amount of time is dynamically determined based on one or more of the user's rate of travel, current traffic conditions, current road conditions, and a time of day. In certain embodiments, the dynamically determined directions to the location associated with the advertisement are based on a direction that the user is currently travelling such that the user does not travel in an opposite direction to arrive at the location associated with the advertisement.

In one embodiment, the code is executable by the processor to integrate the dynamically determined directions with a navigation program executing on a device associated with the user such that a route to the location associated with the advertisement is presented in the navigation program. In certain embodiments, the code is executable by the processor to generate a customized offer for the user based on the user's context and dynamically inject the customized offer into the advertisement and/or provide the customized offer to the user on the user's device.

In one embodiment, the code is executable to select the advertisement from a predefined list of advertisers that are located within a proximity of the user's location. In further embodiments, the current context of the user is determined based on one or more preferences for the user. The code may be executable by the processor to select the determined content based on the one or more preferences for the user. The one or more preferences may be determined based on one or more of social media data, purchase history data, browsing data, interests, and previous location data.

In one embodiment, the current context of the user is determined based on a time period and the code is executable by the processor to select the determined content based on one or more of a current time of day, a season, a holiday, and an event. In some embodiments, the current content stream comprises an audio content stream.

A method for context-based content injection into content stream, in one embodiment, includes determining, by a processor a current context of a user, the current context of the user comprising one or more current environmental circumstances associated with the user, determining content to present to the user that is relevant to the user's current context, and dynamically injecting the determined content into a current content stream that the user is consuming.

In one embodiment, the current context of the user comprises a current location for the user, the determined content associated with the user's location. In further embodiments, the determined content comprises an advertisement for a product and/or service within a proximity of the user's current location. In various embodiments, the method includes dynamically determining directions from the user's current location to a location associated with the advertisement and injecting the dynamically determined directions into the advertisement.

In one embodiment, the method includes dynamically determining an amount of time for the user to arrive at the location associated with the advertisement and injecting the determined amount of time into the content stream as part of the advertisement. In further embodiments, the method includes integrating the dynamically determined directions with a navigation program executing on a device associated with the user such that a route to the location associated with the advertisement is presented in the navigation program.

A computer program product for context-based content injection into content stream, in one embodiment, includes a computer readable storage medium having program instructions embodied therewith. In certain embodiments, the program instructions are executable by a processor to cause the processor to determine a current context of a user, the current context of the user comprising one or more current environmental circumstances associated with the user, determine content to present to the user that is relevant to the user's current context, and dynamically inject the determined content into a current content stream that the user is consuming.

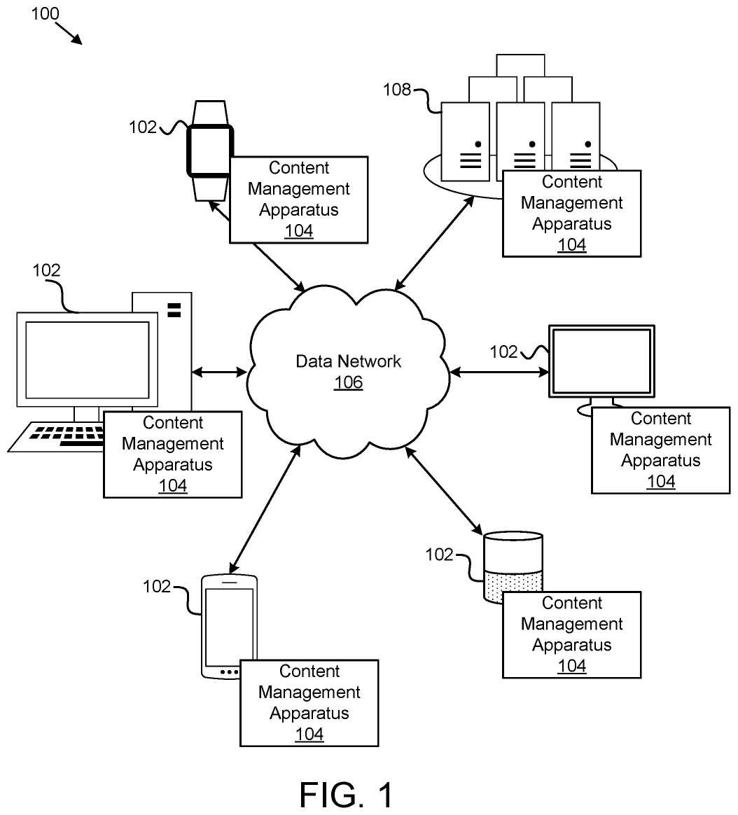

FIG. 1 is a schematic block diagram illustrating one embodiment of a system 100 for context-based content injection into content stream. In one embodiment, the system 100 includes one or more information handling devices 102, one or more content management apparatuses 104, one or more data networks 106, and one or more servers 108. In certain embodiments, even though a specific number of information handling devices 102, content management apparatuses 104, data networks 106, and servers 108 are depicted in FIG. 1, one of skill in the art will recognize, in light of this disclosure, that any number of information handling devices 102, content management apparatuses 104, data networks 106, and servers 108 may be included in the system 100.

In one embodiment, the system 100 includes one or more information handling devices 102. The information handling devices 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, an in-car computing device, a navigation system, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

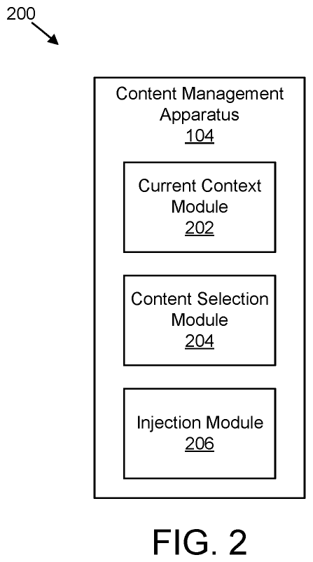

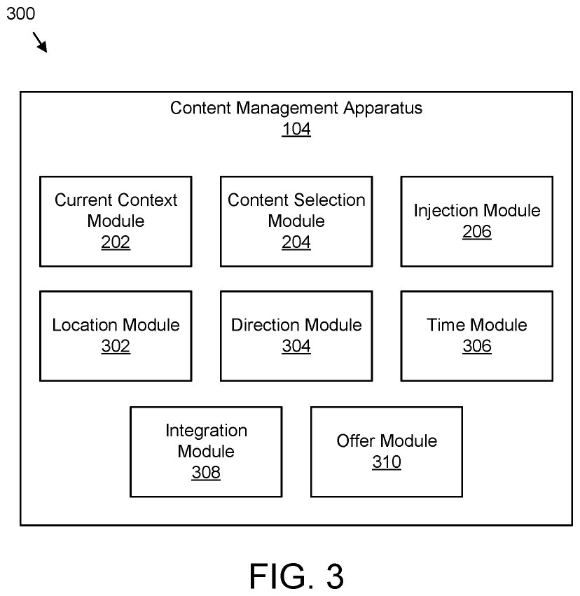

In one embodiment, the content management apparatus 104 is configured to determine a current context of a user, the current context of the user comprising one or more current environmental circumstances associated with the user, determine content to present to the user that is relevant to the user's current context, and dynamically inject the determined content into a current content stream that the user is consuming. The content management apparatus 104, including its various sub-modules, may be located on one or more information handling devices 102 in the system 100, one or more servers 108, one or more network devices, and/or the like. The content management apparatus 104 is described in more detail below with reference to FIGS. 2 and 3.

In various embodiments, the content management apparatus 104 may be embodied as part of an information handling device 102 such as a smart device, a network device, an Internet of Things device, a computing device, a conference call device (e.g., a speaker, microphone, headset, or the like), or as a hardware appliance that can be installed or deployed on an information handling device 102, on a server 108, on a user's mobile device, on a display, or elsewhere on the data network 106.

In certain embodiments, the content management apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like.

A hardware appliance of the content management apparatus 104 may include a power interface, a wired and/or wireless network interface, a graphical interface that attaches to a display, and/or a semiconductor integrated circuit device as described below, configured to perform the functions described herein with regard to the content management apparatus 104.

The content management apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like.

In one embodiment, the content management apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the content management apparatus 104.

The semiconductor integrated circuit device or other hardware appliance of the content management apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the content management apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102 and may host, store, stream, or the like applications, files, media, advertisements, and/or other content associated with streaming audio, video, and/or the like.

FIG. 2 is a schematic block diagram illustrating one embodiment of an apparatus 200 for context-based content injection into content stream. In one embodiment, the apparatus 200 includes an instance of a content management apparatus 104. In one embodiment, the content management apparatus 104 includes one or more of a current context module 202, a content selection module 204, and an injection module 206, which are described in more detail below.

In one embodiment, the current context module 202 is configured to determine a current context of a user. As used herein, the current context of the user may include one or more current environmental circumstances associated with the user. For example, the user's context may include the user's current and/or previous locations; the time of day, season, date, event, holiday, or the like; the user's preferences and/or interests; the user's shopping history; the user's browsing history; the user's social media data; the current media that the user is consuming; the user's usage history of a mobile device or application; the user's phone call and/or text message history; the subject matter of the user's email messages; and/or the like.

For instance, the current context module 202 may use the user's electronic credentials to access the user's social media data (e.g., social media posts, likes, shares, tweets, and/or the like); may access the user's browsing history from a browser application; may access the user's shopping history from an ecommerce site (e.g., Amazon®) using the user's electronic credentials; may dynamically determine the user's current location (described below); may use calendar data to determine if it is near a holiday, e.g., Christmas and/or near an event, e.g., the Super Bowl; and/or the like.

In one embodiment, the content selection module 204 is configured to determine content to present to the user that is relevant to the user's current context. For example, the content may include an advertisement, an offer, a message, a commercial, a public service announcement, a video clip, and/or the like. The selected content may include content for the type of media that the user is consuming. For instance, if the user is listening to streaming audio, the content will be audio, but if the user is streaming video content, the selected content for the user may include video content.

The content selection module 204 may use the user's current context to lookup, reference, find, search, and/or the like content to present to the user. For instance, the content selection module 204 may use a combination of the user's current location and the user's parsed emails/texts/preferences/social media information to search for an advertisement related to the user's interests for a product or service that is available within a certain proximity of the user's current location, e.g., within 10 miles, or the like.

For example, the content selection module 204 may determine the user's interests, preferences, or the like and then dynamically select an advertisement for products/services related to the user's interests/preferences that are within a predetermined threshold proximity of the user's location, e.g., within a 1 mile radius, 5 mile radius, and/or the like.

In certain embodiments, the content selection module 204 may check a predefined list of content, e.g., advertisements, associated with the user's location, for example. The predefined list may be derived from companies/organizations that have paid or otherwise provided consideration to be placed on the list, to be placed on a particular location on the list, to be associated with certain keywords, and/or the like.

In some embodiments, the content selection module 204 may select content that is particularly relevant to the user's preferences/interests. For instance, if context module 202 determines that the user is vegan, e.g., based on social media data, based on purchase history information, or the like, the content selection module 204 may present a list of vegan offerings on a fast food restaurant's menu as part of the advertisement for the fast food restaurant.

In one embodiment, the injection module 206 is configured to dynamically inject the determined content into a current content stream that the user is consuming. A content stream, as used herein, may include audio provided by a streaming service such as Spotify®, Pandora®, or the like; may include video provided by a streaming service such as YouTube®, Netflix®, and/or the like.

The injection module 206, in certain embodiments, receives the content that the content selection module 204 selects for the user and dynamically inserts, injects, presents, displays, plays, or the like the selected content into the streaming media content while the user is consuming the content. For instance, the injection module 206 may insert a targeted advertisement within an audio stream when a song is finished playing. The injection module 206 may select a particular point in the stream to inject the content such as when the user is at a particular location, when the user is within a predefined proximity of a location (e.g., a location associated with an advertisement), and/or the like.

For example, the injection module 206 may present the user with relevant, targeted, personal, or the like content during commercial breaks while the user is listening to Pandora® or Amazon Music®. In this manner, the user can be presented with targeted, personalized, and custom content that is selected/generated based on the user's current context and presented to the user within a content stream while the user is consuming the content stream.

FIG. 3 is a schematic block diagram illustrating one embodiment of an apparatus 300 for context-based content injection into content stream. In one embodiment, the apparatus 300 includes an instance of a content management apparatus 104. In one embodiment, the content management apparatus 104 includes one or more of a current context module 202, a content selection module 204, and an injection module 206, which may be similar to the current context module 202, the content selection module 204, and the injection module 206 described above with reference to FIG. 2. In further embodiments, the content management apparatus 104 includes one or more of a location module 302, a direction module 304, a time module 306, an integration module 308, and an offer module 310, which are described in more detail below.

In one embodiment, the location module 302 is configured to determine, monitor, track, or the like the user's current location, e.g., using GPS or other location services on the user's device, in the user's vehicle (e.g., as part of the in-car navigation or infotainment system), and/or the like. The location module 302, for example, may be located on a server at a remote location where the media content is being streamed from, e.g., Spotify's servers may ping, query, poll, or the like the location module 302 on the user's device that the content is being streamed to, the location module 302 on the user's mobile device, or the like for the user's location. Alternatively, or in addition, the location module 302 on the user's device may periodically send the user's location to the location module 302 located on the streaming servers.

The location data may include GPS location data, latitude/longitude location data, physical address location data, location data relative to a point of interest (e.g., a restaurant, store, landmark, or the like). The location data may comprise at least one of the variables, factors, indicators, or the like of the current context of the user, and which the content selection module 204 may use to select a content item, e.g., an advertisement, offer, or the like, to inject into the media stream.

For instance, the content selection module 204 may select an advertisement for a product and/or a service that is located within a predefined proximity of the user's location (e.g., within a 10 mile radius), that is located a certain distance from the user (e.g., within a 10 mile range ahead of the user's location), and/or the like. In certain embodiments, the content selection module 204 selects an advertisement from a predefined list of advertisers that are located within a proximity of the user's location. For instance, the content selection module 204 may select an advertisement for a fast food restaurant, for a gas station, for a grocery store, for a retail store, and/or the like that are within a mile, a few miles, 10 miles, and/or the like of the user.

In one embodiment, the direction module 304 is configured to dynamically determine directions from the user's current location to a location associated with the advertisement. For example, if the user is driving on a freeway or highway and the advertisement is for a fast food restaurant that is located off of the freeway/highway, the direction module 304 may determine one or more routes to the fast food restaurant from the user's location, and may dynamically update the directions as the user continues to travel.

In one embodiment, the direction module 304 dynamically injects the dynamically determined directions into the advertisement. For instance, the injection module 206 may append or insert the specific directions into a custom advertisement or into a generic, premade advertisement. For instance, the direction module 304 may append a phrase such as “take the next exit,” “take exit 123,” “turn right one mile ahead,” and/or the like.

In one embodiment, the dynamically determined directions to the location associated with the advertisement are based on a direction that the user is currently travelling such that the user does not travel in an opposite direction to arrive at the location associated with the advertisement. For example, if the user is travelling east, the direction module 304 may determine directions for locations associated with advertisements that are “ahead” of the user, located further east of the user, located within a predefined radius of the user (e.g., within a 2 mile radius), or the like.

In this manner, the user does not have to double-back or turn around to find a location associated with an advertisement. In another example embodiment, if the context module 202 determines that fast food is one of the user's preferences and it is close to the user's typical lunch or dinner time (as determined based on activity data collected on the user's mobile device), the direction module 304 could present directions to the nearest fast food restaurant to the user's location in the user's direction of travel.

In one embodiment, the time module 306 is configured to dynamically determine an amount of time for the user to arrive at the location associated with the advertisement from the user's current location and inject the determined amount of time into the content stream as part of the advertisement. For instance, the time module 306 may inject phrases such as “turn right in two minutes,” “you're five minutes away,” and/or the like.

In one embodiment, the amount of time that the time module 306 determines is dynamically determined based on one or more of the user's rate of travel, current traffic conditions, current road conditions, and a time of day. For instance, the time module 036 may take into consideration current traffic conditions received from a traffic application/server (e.g., a government traffic agency, a traffic application such as Waze®, and/or the like); may consider the time of day and/or day of the week (e.g., rush hour on a Monday, noon on Sunday, or the like); weather conditions (e.g., bad weather may slow traffic down); speed limits on certain stretches of the user's route; and/or the like.

In one embodiment, the integration module 308 is configured to integrate the dynamically determined directions with a navigation program executing on a device associated with the user such that a route to the location associated with the advertisement is presented in the navigation program. For instance, when an advertisement to a fast food restaurant is injected into the streaming content, the integration module 308 may dynamically display one or more routes to the location of the fast food restaurant on the user's navigation program, e.g., an in-car navigation system, a navigation program executing on the user's mobile device (e.g., Google Maps), and/or the like.

In one embodiment, the offer module 310 is configured to generate a customized offer for the user based on the user's context. For instance, the offer module 310 may dynamically provide an offer, coupon, or the like for a fast food restaurant that is within a proximity of the user's location. For example, the offer module 310 may provide a buy one, get one free offer, a percent discount offer, and/or the like for a McDonald's® that is within a mile of the user's location based on the user's purchase history indicating that the user has purchased food at McDonald's® in the past. Or the offer may be for particular foods that the user enjoys, e.g., vegan foods, drinks, meals, desserts, and/or the like.

In certain embodiments, the offer module 310 dynamically injects the customized offer into the advertisement and/or provides the customized offer to the user on the user's device. For example, the offer module 310 may provide the offer as part of an audio advertisement (e.g., “stop now for 20% off”) and may provide a code, or the like, to get the offer, may provide a digital coupon on the user's device (e.g., within the user's navigation program), and/or the like.

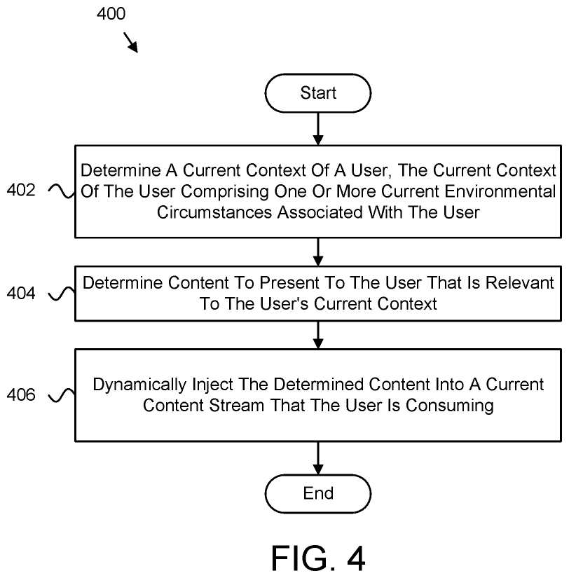

FIG. 4 is a schematic flow chart diagram illustrating one embodiment of a method 400 for context-based content injection into content stream. In one embodiment, the method 400 begins and determines 402 a current context of a user. The current context of the user may include one or more current environmental circumstances associated with the user.

In certain embodiments, the method 400 determines 404 content to present to the user that is relevant to the user's current context. In further embodiments, the method 400 dynamically injects 406 the determined content into a current content stream that the user is consuming, and the method 400 ends. In one embodiment, the context module 202, the content selection module 204, and the injection module 206 perform the various steps of the method 400.

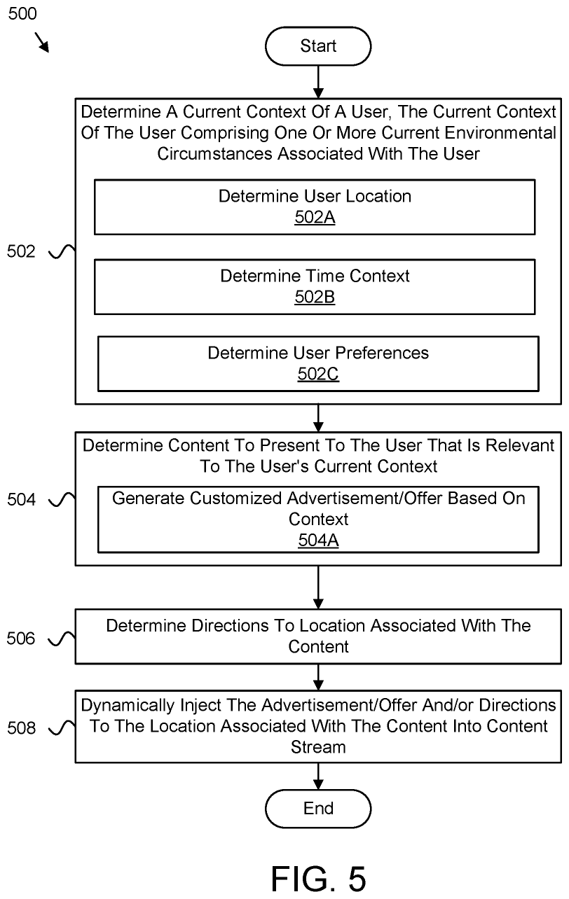

FIG. 5 is a schematic flow chart diagram illustrating one embodiment of another method 500 for context-based content injection into content stream. In one embodiment, the method 500 begins and determines 502 a current context of a user. The current context of the user may include one or more current environmental circumstances associated with the user. For instance, the method 500 may determine 502A the user's location, may determine 502B various time-based factors (e.g., time of day, holiday, current events such as sporting events or the like), and/or may determine 502C the user's preferences/interests.

In one embodiment, the method 500 determines 504 content to present to the user that is relevant to the user's current context. For instance, in one embodiment, the method 500 generates or selects 504A customized advertisements, offers, or the like for the user based on the user's location, interests, preferences, purchase history, browsing history, and/or the like.

In some embodiments, the method 500 dynamically determines 506 directions to a location associated with the selected advertisement based on the user's current location and dynamically injects 508 the advertisement/offer, including the determined directions, into the content or media stream, and the method 500 ends. In one embodiment, the context module 202, the content determination module 204, the injection module 206, the location module 302, and the direction module 304 perform the various steps of the method 500.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor; and
a memory that stores code executable by the processor to:
determine a current context of a user, the current context of the user comprising one or more current environmental circumstances associated with the user;
determine content to present to the user that is relevant to the user's current context; and
dynamically inject the determined content into a current content stream that the user is consuming.

2. The apparatus of claim 1, wherein the current context of the user comprises a current location for the user, the determined content associated with the user's location.

3. The apparatus of claim 2, wherein the determined content comprises an advertisement for a product and/or service within a proximity of the user's current location.

4. The apparatus of claim 3, wherein the code is executable by the processor to dynamically determine directions from the user's current location to a location associated with the advertisement and inject the dynamically determined directions into the advertisement.

5. The apparatus of claim 4, wherein the code is executable by the processor to dynamically determine an amount of time for the user to arrive at the location associated with the advertisement from the user's current location and inject the determined amount of time into the content stream as part of the advertisement.

6. The apparatus of claim 5, wherein the amount of time is dynamically determined based on one or more of the user's rate of travel, current traffic conditions, current road conditions, and a time of day.

7. The apparatus of claim 4, wherein the dynamically determined directions to the location associated with the advertisement are based on a direction that the user is currently travelling such that the user does not travel in an opposite direction to arrive at the location associated with the advertisement.

8. The apparatus of claim 1, wherein the code is executable by the processor to integrate the dynamically determined directions with a navigation program executing on a device associated with the user such that a route to the location associated with the advertisement is presented in the navigation program.

9. The apparatus of claim 2, wherein the code is executable by the processor to generate a customized offer for the user based on the user's context and dynamically inject the customized offer into the advertisement and/or provide the customized offer to the user on the user's device.

10. The apparatus of claim 2, wherein the code is executable to select the advertisement from a predefined list of advertisers that are located within a proximity of the user's location.

11. The apparatus of claim 1, wherein the current context of the user is determined based on one or more preferences for the user, the code being executable by the processor to select the determined content based on the one or more preferences for the user, the one or more preferences determined based on one or more of social media data, purchase history data, browsing data, interests, and previous location data.

12. The apparatus of claim 1, wherein the current context of the user is determined based on a time period and the code is executable by the processor to select the determined content based on one or more of a current time of day, a season, a holiday, and an event.

13. The apparatus of claim 1, wherein the current content stream comprises an audio content stream.

14. A method, comprising:
determining, by a processor, a current context of a user, the current context of the user comprising one or more current environmental circumstances associated with the user;
determining content to present to the user that is relevant to the user's current context; and
dynamically injecting the determined content into a current content stream that the user is consuming.

15. The method of claim 14, wherein the current context of the user comprises a current location for the user, the determined content associated with the user's location.

16. The method of claim 15, wherein the determined content comprises an advertisement for a product and/or service within a proximity of the user's current location.

17. The method of claim 16, further comprising dynamically determining directions from the user's current location to a location associated with the advertisement and injecting the dynamically determined directions into the advertisement.

18. The method of claim 17, further comprising dynamically determining an amount of time for the user to arrive at the location associated with the advertisement and injecting the determined amount of time into the content stream as part of the advertisement.

19. The method of claim 14, further comprising integrating the dynamically determined directions with a navigation program executing on a device associated with the user such that a route to the location associated with the advertisement is presented in the navigation program.

20. A computer program product, comprising a computer readable storage medium having program instructions embodied therewith, the program instructions executable by a processor to cause the processor to:
determine a current context of a user, the current context of the user comprising one or more current environmental circumstances associated with the user;
determine content to present to the user that is relevant to the user's current context; and
dynamically inject the determined content into a current content stream that the user is consuming.
